(19) United States
(12) Patent Application Publication
(10) Pub. No.: US 2008/0162046 A1
(43) Pub. Date: Jul. 3, 2008

(54) METHOD AND SYSTEM FOR TRACKING AN ARRANGEMENT OF MEDICAL APPARATUSES

(75) Inventors: Francois Kotian, Villepreux (FR); Yann Delmas, Meudon (FR)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/552,286

(22) Filed: Oct. 24, 2006

(51) Int. Cl. G06G 7/78; G05D 1/02; G06F 17/10

(52) U.S. Cl. 701/300

(57) ABSTRACT

A system for tracking an arrangement of at least one mobile apparatus in relation to an imaging device is provided. The system includes at least one position monitoring sensor in communication with a controller. The position monitoring sensor is operable to generate a signal indicative of a position of the at least one mobile apparatus relative to a reference point. The controller is operable to calculate a position of the at least one mobile apparatus relative to the imaging device, and store the position of the at least one mobile apparatus relative to the imaging device in a storage medium.

### BACKGROUND OF THE INVENTION

This invention generally relates to an imaging system, and more specifically, to a system for and a method of tracking an arrangement of medical apparatuses.

Conventional imaging system (e.g., radiological) generally includes a variety of static and dynamic components (e.g., gantry supporting a monitor boom, computer workstations, C-arm, cabinets etc.). In addition, a room for performing a medical procedure can include various types of other medical apparatuses (e.g., hemodynamic system, respirator, injector, ultrasound system, surgery lights, etc.) that may or may not be utilized in the medical procedure.

The drive for enhancements in healthcare technology and efficiency has created ever more complex imaging systems and medical apparatuses to be employed in rooms where real estate is highly valued. As medical procedures utilize more and more complex imaging systems, as administrators desire more efficiency in medical procedures and transition between medical procedures to and from the rooms, there is a need to track the position of the imaging system in relation to the various other medical apparatuses and clinicians in the confined space of the room so as to avoid opportunities of collisions that can cause damage to the costly imaging system or medical apparatuses, as well as hinder the medical procedure and efficiency.

### BRIEF DESCRIPTION OF THE INVENTION

The above-mentioned shortcomings, disadvantages and problems are addressed by the embodiments described herein in the following description.

In one embodiment, a system for tracking an arrangement of at least one mobile apparatus in relation to an imaging device is provided. The system includes a position monitoring sensor in communication with a controller. The position monitoring sensor is operable to generate a signal indicative of a position of the at least one mobile apparatus relative to a reference point. The controller includes a processor in communication with a memory having a plurality of program instructions executable by the processor. The plurality of program instructions include the acts of calculating a position of the at least one mobile apparatus relative to the imaging device, and storing the position of the at least one mobile apparatus relative to the imaging device in a storage medium.

In another embodiment, a method of tracking a mobile apparatus in relation to an imaging device is provided. The method comprises the acts of receiving and storing a first geometric description representative of the imaging device; receiving and storing a second geometric description representative of the at least one mobile apparatus; measuring a location of the at least one mobile apparatus relative to a reference point; calculating a likelihood of at least a partial interference of the at least one mobile apparatus with the imaging device based on the location of the at least one mobile apparatus and the first and second geometric descriptions; and causing an automatic control of a motion of the imaging device based on the likelihood of the at least the partial interference.

Arrangements of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an embodiment of at least one position monitoring sensor employed in a tracking system to electromagnetically track positions of an imaging system and medical apparatuses employed in a medical procedure.

FIG. 2 shows a schematic diagram of another embodiment of a position monitoring sensor employed in the tracking system to optically track positions of an imaging system and medical apparatuses employed in a medical procedure.

FIG. 3 shows a schematic diagram of another embodiment of a position monitoring sensor in communication with a satellite to track positions of an imaging system and medical apparatuses employed in a medical procedure.

FIG. 4 shows a schematic diagram of a map illustrating tracked positions of geometric representations of the imaging system and medical apparatuses employed in a medical procedure as monitored by the tracking system in FIG. 1.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

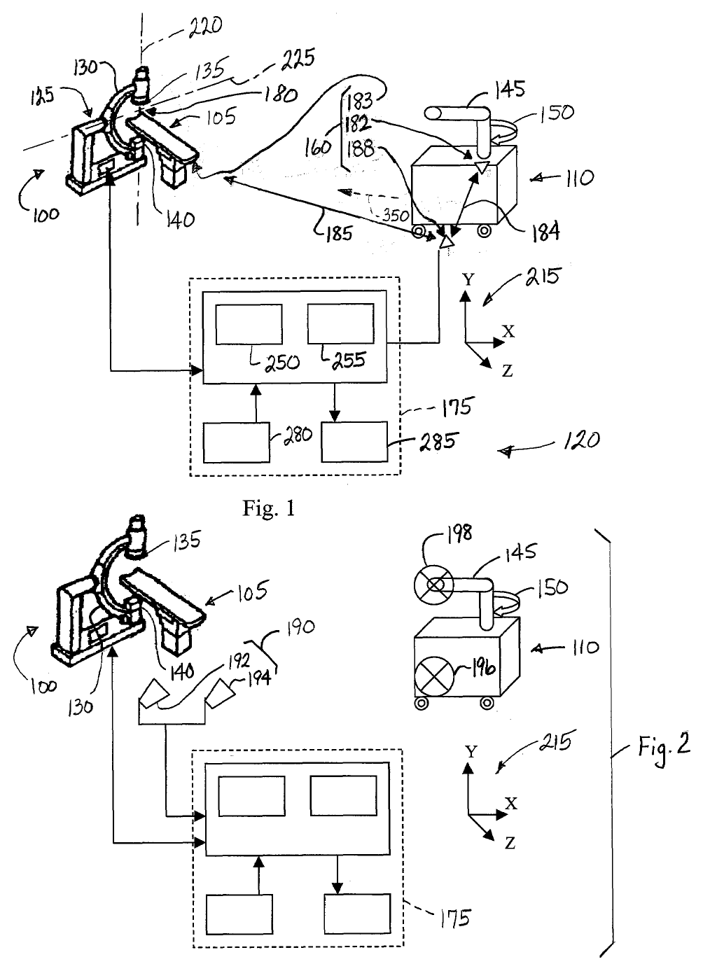

FIG. 1 illustrates an embodiment of an imaging system 100 and a series of medical equipment 105 and 110 in combination with a tracking system 120. The imaging system 100 is a mobile radiological X-ray system having a gantry 125 with a mobile C-arm 130 in support of a radiation source 135 and detector 140 operable to generate a radiological image of a subject (not shown). Yet, the imaging system 100 can be also fixed to the ground with miscellaneous moving components. Although a mobile radiological imagine system is shown, it should be understood that the type (e.g., X-ray, magnetic resonant imaging (MRI), ultrasound, fluoroscopic, endoscopic, laparoscopic, etc.) of imaging system 100 can vary.

The illustrated medical apparatuses 105 and 110 include a table 105 located so as to receive the subject to be imaged by the imaging system 100. The table 105 can be configured to elevate, pan, tilt, or cradle so as to position the imaged subject in a desirable fashion for imaging by the imaging system 100. The medical apparatuses 110 can include an anesthesia machine, an ultrasound machine, or any other conventional type of medical apparatus that may be employed in a conventional manner with the imaging system for performing a medical procedure. Although only two apparatuses 105 and 110 are shown, the type and number of medical apparatuses 105 and 110 can vary. Also, one or more of the medical apparatuses 105 and 110 can include at least one movable component (e.g., pivotal or retractable arms, legs, etc.) 145 in a direction (represented by arrow and reference 150) in relation to the medical equipment 105 and 110. The number and type of at least one movable component 145 can vary. Also, the direction (e.g., rotational, linear, etc.) of movement 150 of the movable component 145 can vary.

A technical effect of the tracking system 120 is to periodically or continuously track or monitor a static or change in location or position of a series of medical apparatuses 105 and 110 and movable components 145 associated therewith relative to the imaging system 100 for storage or for illustration to an operator. The embodiment of the tracking system 120 generally includes at least one position monitoring sensor 160 in communication (e.g., wireless, wired, etc.) with a controller 175. The controller 175 is also connected in communication (e.g., wireless, wired, etc.) with the imaging system 100.

The at least one position monitoring sensor 160 is generally configured periodically or continuously measure a location or position of the medical apparatus 105 and 110 relative to a reference 180. The at least one monitoring sensor 160 is also operable to generate a signal representative of an identifier with the measured location or position data of the respective medical apparatuses 105 and 110 relative to the reference 180 for communication to the controller 175. Alternatively, the controller 175 can calculate the position of the medical apparatuses 105 and 110 relative to the reference 180 based on the identifier and location data received from the at least one position monitoring sensor 160.

As shown in FIG. 1, an embodiment of the at least one position monitoring sensor 160 is operable to electromagnetically measure the location of the medical apparatuses 105 and 110. The at least one position monitoring sensor 160 can include an arrangement of transmitters 182 and 183 in communication (represented by arrows and references 184 and 185, respectively) with receiver 188 operable to electromagnetically measure and generate the signal representative of the identifier and the location of the medical apparatuses 105 and 110 for communication to the controller 175. It should be understood that the location of the transmitters 182 and 183 and receivers 188 can vary. The signal from the at least one position monitoring sensor 160 can also include position data indicative of an orientation (e.g., an angle of rotation) of the medical equipment 105 and 110. In an embodiment, the at least one position monitoring sensor 160 can electromagnetically measure a location and orientation of the respective medical apparatuses 105 and 110. Also, the at least one position monitoring sensor 160 can be configured to electromagnetically measure a location or position of the movable component 145, and to generate a signal representative of an identifier and the measured location of the movable component 145 relative to the reference point 180 for communication to the controller 175.

FIG. 2 illustrates another embodiment of a position monitoring sensor 190 (illustrated in phantom line) configured to optically measure the location and an orientation of the medical apparatuses 105 and 110 and moveable component 145 for communication to the controller 175. The positioning monitoring sensor 190 includes a pair of camera devices 192 and 194 operable to detect and generate a signal representative of an identifier and a measured location and orientation of optical markers 196 and 198 located on the medical apparatus 110 and the moveable component 115, respectively. An example of the optical markers 196 and 198 can include three spaced apart, predetermined points (not shown) that are identifiable with the camera devices 192 and 194. Yet, the type of optical markers 196 and 198 can vary.

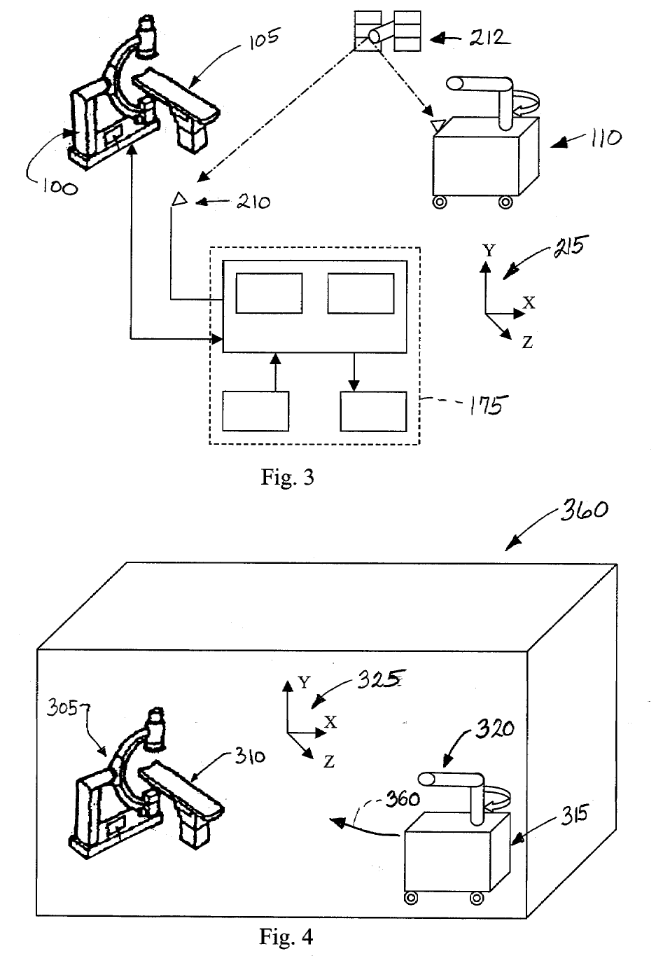

FIG. 3 illustrates yet another embodiment of a position monitoring sensor 210 comprising transmitters and receivers configured to communicate with a satellite 212 (e.g., global positioning system) so as to measure a precise location of the medical apparatuses 105 and 110 and moveable component 115 relative to the imaging system 100 for communication to the controller 175.

Although embodiments of the position monitoring sensors 160, 190 and 210 are described above with reference FIGS. 1-3, it should be understood that the number and types (e.g., electromagnetic, optical, rf, accelerometers, etc. or combination thereof) and combinations of location measuring techniques employed by the at least one position monitoring sensors 160, 190 and 210 can vary.

Referring back to FIG. 1, the reference point 180 is generally a predetermined location or coordinate in a coordinate system 215 (e.g., in the x-y-z coordinate system) stored at the controller 175 that is used to track or monitor the position of the medical apparatuses 105 and 110 and movable components 145 associated therewith. An embodiment of a location of the reference point 180 is an iso-center of the gantry 125 of the imaging system 100, where a direction 220 of radiation transmission from the radiation source 135 to the radiation detector 140 intersects an axis of rotation 225 of the C-arm 130. Yet, the reference point 180 can be located generally anywhere in a room with the imaging system 100.

The controller 175 is generally operable to receive the signals from the at least one position monitoring sensor 160 and translate into the location and/or orientation data relative to the reference point 180. The controller 175 generally includes a processor 250 operable to execute program instructions stored in a memory 255. The memory 255 can include any type of conventional storage medium (e.g., disk, hard-drive of a computer, network database, etc.). The controller 175 is connected in communication (e.g., wireless, wired, etc.) with the imaging system 100 and the at least one position monitoring sensor 160. One embodiment of the location of the controller 175 is embedded at the imaging system 100. Yet, the location of the controller 175 can vary.

Still referring to FIG. 1, the controller 175 can further include an input 280 and an output 285. The input 280 can include a keyboard, a touch-screen, etc. or other known type of input device operable to communicate information to the controller 175. The output 285 can include a monitor, a touch-screen, audible alarm, etc. operable to receive information from the controller 175 for communication to an operator.

Having generally described the construction of an embodiment of the tracking system 120 in combination with the imaging system 100 and medical apparatuses 105 and 110 and moveable component 145, the following is a description of an operation of the tracking system 120.

In one embodiment as shown in FIG. 1, the tracking system 120 continuously or periodically tracks and calculates a position of the mobile medical apparatuses 105 and 110, and movable component 145 associate therewith, and moving components (e.g., C-arm 130, etc.) of the imaging system 100, in relation to the reference point 180 located at the iso-center of the imaging system 100. Based on this tracked information, the tracking system 120 can identify and communicate signals to the imaging system 100 so as to control movement of the C-arm 130 or other components of the imaging system 100 to avoid collision or interference with the mobile apparatuses 105 and 110.

Referring now to FIG. 4, an embodiment of the controller 175 (See FIGS. 1-3) receives and stores geometric envelopes or representations 305, 310, 315, and 320 of the three-dimensional space occupied by the imaging system 100, medical apparatus 105 and 110, and movable components 145, respectively (See FIGS. 1-3). Embodiments of the geometric representations 305, 310, 315 and 320 can include one or more various details and shapes (e.g., lines, curves, blocks, cubes, cylinders, etc.) operable to be represented in a coordinate system 325 (e.g., x-y-z, polar, etc.). The information defining the geometric representations 305, 310, 315 and 320 can be pre-programmed at the imaging system 100 and/or in the memory 255 of the tracking system 120 based on information obtained from a third party (e.g., the manufacturer). The controller 175 can also receive and store identifier with each geometric representation 305, 310, 315 and 320 that are also associated with the origin of the location data of the imaging system 100, the apparatuses 105 and 110 and the movable components 145.

Referring back to FIG. 1, the controller 175 is connected in communication to receive signals representative of the identifiers and the position or change in position of one or series of moving components (e.g., C-arm 130 or other mobile components of the gantry 125, etc.) of the imaging system 100. The signals can be automatically communicated to the controller 175 with movement and/or periodically or continuously updated. The controller 175 stores the updated position of the imaging system 100 with the identifier represented in each signal in the memory 255. The controller 175 is also connected to receive signals from at least position monitoring sensor 160 indicative of the identifier and updated location of the respective medical apparatuses 105 and 110 and movable component 145 on a periodic or continuous basis. The controller 175 also stores the updated position of the medical apparatuses 105 and 110 and moving components 145 in the memory 255.

Referring to FIGS. 1 and 4, using the acquired location or position data of the imaging system 100, the acquired location data from the at least one position monitoring sensor 160, and the geometric representations 305, 310, 315, and 320 (See FIG. 4) of the imaging system 100, the medical apparatuses 105 and 100 and movable component 145, respectively, the controller 175 calculates whether a position of any one or more of the imaging system 100, the medical apparatus 105 and 100, and movable component 145 in relation to another is within a predetermined distance so as to create an alarm signal. The controller 175 is also operable to calculate and identify a projected path (illustrated by dashed arrow and reference 350) of any one of the imaging system 100, the medical apparatuses 105 and 110, the movable components 145 relative to one another, the reference point 180, and the room. The projected path 350 can be calculated using acquired position data and various mathematical techniques (e.g., least squares fitting, simple or multiple linear regression analysis, linear or non-linear regression analysis, etc.) to approximate the path 350 to the acquired position data. Upon calculating the projected path 350, the controller 175 can calculate a likelihood of an interference or collision of the imaging system 100, the medical apparatuses 105 and 110, and the movable component 145 with one another. The position monitoring sensor 160 of the tracking system 120 can also be configured to track a position of one or more clinicians, in relation to the imaging system 100, medical apparatuses 105 and 110 and movable components 145, calculate a likelihood of collision of the one or more clinicians, the imaging system 100, the medical apparatuses 105 and 110, and the movable components 145 with one another.

The controller 175 can also combine the identifier and location data acquired from the imaging system 100 and the at least one position monitoring sensor 160 with geometric representations 305 of the imaging system 100 and/or geometric representations 310, 315 and 320 (See FIG. 4) for the medical apparatuses 105 and 110 and moving components 145 thereof, to create a graphical illustration or map 360 (See FIG. 4). The illustrated embodiment of the map 360 generally includes a graphic, three-dimensional representation that both statically and dynamically illustrates the tracked position of the imaging system 100 and the medical apparatuses 105 and 110 and movable components 145 (See FIG. 1) in relation to one another relative to the coordinate system 320 (See FIG. 4). The map 360 is generally comprised of the geometric representation 305 of the imaging system 100 (FIG. 1) and geometric representations 310 and 315 of the medical apparatuses 105 and 110 (See FIG. 1), respectively, and geometric representation 325 of the movable components 145 (See FIG. 1). The map 360 can further include a geometric representation 352 of the room dimensions where the imaging system 100, the apparatuses 105 and 110 are located. The controller 175 periodically or continuously updates the map 360 with acquired changed data/information from the at least one position monitoring sensor 160. The map 360 can be stored in a virtual format in the memory 255 and/or communicated for visual display or viewing at the output 285. Via the map 360, the controller 175 is operable to calculate and identify the likelihood of a collision of the imaging system 100, the medical apparatuses 105 and 110, and the movable components 115 with one another or walls defining the room.

In response to detecting a likelihood of a collision or interference using any one of the above-described techniques, the controller 175 generates an alarm signal operable to cause at least one of the following: automatically cause the imaging system 100 to move in avoidance of the projected interference or collision, automatically stop motion of the imaging system 100, and cause an audible alert and/or a visual alert at the output 285. Yet, other types of alarm or alerts can be used which are operable to indicate the likelihood of a collision to the operator. Another embodiment of the alarm can further include a graphic geometric representation 365 (See FIG. 4) of the projected path 350 (See FIG. 1) and highlight or flash the geographic representation 305, 310, 315 and 320 (See FIG. 4) of the potential obstacle on the map 360 (See FIG. 4) for display to the operator.

The embodiment of the tracking system 120 in combination with an imaging system 100 and medical apparatuses 105 and 110, and movable components 145 associated therewith is not limited to the description described above. For example, the imaging system 100 can further include contact switches, proximity sensors, or include a stored x-y representation of the table 105 in its memory 255. Also, it should be understood that the tracking system 120 can be used with any number of geometric representations 305, 310, 315, and 320, position monitoring sensors 160, 190 and 210, medical apparatuses 105 and 110, and movable components 145 associated therewith.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for tracking an arrangement of at least one mobile apparatus in relation to an imaging device, comprising:
a position monitoring sensor operable to generate a signal indicative of a position of the at least one mobile apparatus relative to a reference point;
a controller in communication with the position monitoring sensor, the controller having a processor in communication with a memory having a plurality of program instructions executable by the processing, the plurality of program instructions including the acts:
calculating a position of the at least one mobile apparatus relative to imaging device;
storing the position of the at least one mobile apparatus relative to the imaging device in a storage medium.

2. The system of claim 1, the plurality of program instructions further including the act of identifying if the at least one mobile apparatus is positioned at a predetermined location relative to the reference point.

3. The system of claim 1, wherein the position monitoring sensor is electromagnetic.

4. The system of claim 1, wherein the position monitoring sensor is optical.

5. The system of claim 1, wherein the position monitoring sensor is further operable to measure an orientation of the apparatus for communication via the signal to the controller.

6. The system of claim 1, the system further including a display device in communication with the controller, and wherein the program instructions further include the acts of:
receiving and storing a first geometric description representative of the imaging device;
receiving and storing a second geometric description representative of the at least one mobile apparatus; and
generating a map representative of the position of the second geometric description relative to the first geometric description based on the step of measuring the position of the at least one mobile apparatus relative to the imaging device.

7. The system of claim 6, wherein each of the first and second geometric descriptions is three-dimensional.

8. The system of claim 6, wherein the program instructions further includes the act of calculating if the second geometric description within a predetermined distance of the first geometric description, and wherein in response to calculating the second description being within the predetermined distance of the first geometric description, the controller generates an alarm.

9. The system of claim 6, wherein the program instructions further comprises the acts of receiving a third geometric description of a mobile part attached at and movable in relation to the at least one mobile apparatus; calculating a position of the first geometric description relative to the third geometric description relative to the map.

10. A method of tracking a mobile apparatus in relation to an imaging device, the method comprising the acts of:
receiving and storing a first geometric description representative of the imaging device;
receiving and storing a second geometric description representative of the at least one mobile apparatus;
measuring a location of the at least one mobile apparatus relative to a reference point;
calculating a likelihood of at least a partial interference of the at least one mobile apparatus with the imaging device based on the location of the at least one mobile apparatus and the first and second geometric descriptions; and
causing an automatic control of a motion of the imagine device based on the likelihood of at least the partial interference.

11. The method of claim 10, the method further including the act of creating a map representative of the location of the second geometric description relative to the first geometric description.

12. The method of claim 11, further comprising the act of measuring an orientation of the apparatus relative to the imaging system for illustration on the map.

13. The method of claim 10, the method further including the act of calculating if the apparatus is at a predetermined location based on a calculation of the location of the second geometric description relative to one of the reference point and the location of the first geometric description.

14. The method of claim 10, wherein each of the first and second geometric descriptions is three-dimensional.

15. The method of claim 10, wherein the measuring step is performed electromagnetically.

16. The method of claim 10, wherein the act of calculating a likelihood of interference includes the act of calculating if the first geometric description is located within a predetermined distance of the second geometric description.

17. The method of claim 16, wherein the act of controlling a motion of the imaging device includes stopping movement of the imaging device.

18. The method of claim 10, wherein the program instructions further comprises the acts of receiving a third geometric description of a mobile part attached at and movable in relation to the mobile apparatus; measuring a location of the third geometric description relative to the first geometric description; and creating a map representative of the location of the third geometric description relative to the first geometric.

19. The method of claim 10, wherein the measuring step is performed optically.

20. The method of claim 19, wherein the measuring step includes acquiring position data from a pair of camera devices.
